(19) United States
(12) Patent Application Publication
(10) Pub. No.: US 2008/0169161 A1
(43) Pub. Date: Jul. 17, 2008

(54) Brake moan and groan splitter

(76) Inventor: Jim Chern, Troy, MI (US)

Correspondence Address: FORD GLOBAL TECHNOLOGIES;c/o MOFO NOVA, 1650 TYSONS BLVD., SUITE 300, MCLEAN, VA, 22102, US

(21) Appl. No.: 11/653,906

(22) Filed: Jan. 17, 2007

(51) Int. Cl. F16D 65/092

(52) U.S. Cl. 188/250 B

(57) ABSTRACT

The invention provides a brake pad for decreasing one of brake moan and groan, comprising a brake pad lining with at least one notch located at or near at least one peak area of wave propagation within the brake pad lining. The invention also provides a method of decreasing one of brake moan and groan in a brake pad, comprising providing a brake pad lining with at least one notch located at or near at least one peak area of wave propagation within the brake pad lining. The invention further provides a method of manufacturing a brake pad for decreasing one of brake moan and groan, comprising forming at least one notch in a lining of the brake pad, the at least one notch being located at or near at least one peak area of wave propagation within the brake pad lining.

### FIELD OF THE INVENTION

This invention relates to a device and method for reducing brake moan and groan. More specifically, this invention relates to providing notches in a brake pad lining at or near peak areas of wave propagation.

### BACKGROUND OF THE INVENTION

A disc brake is a device for slowing or stopping the rotation of a wheel, for example in an automobile. A brake rotor (or disc), usually made of cast iron or ceramic, is connected to the wheel or the axle. To stop the wheel, friction material in the form of brake pads (mounted in a device called a brake caliper) is forced mechanically, hydraulically, pneumatically, or electromagnetically against both sides of the rotor. Friction causes the rotor and attached wheel to slow or stop.

Brake linings are composed of a relatively soft but tough and heat-resistant material with a high coefficient of dynamic friction, which is typically mounted to a solid metal backing using high-temperature adhesives or rivets. The complete assembly (including a lining and a backing) is often called a brake pad.

Disc brakes are prone to generating undesirable noises during braking, which are variously described as squeals, chirps, grunts, moans, and groans. In general, different noises have different frequencies. For example, brake moan occurs at about 100 Hz-400 Hz, whereas squeals occur at about 2000 Hz and above. These noises are generated in disc brakes by pressurized application of brake linings to the rotors as the rotors are rotating. Brake moan and groan typically occur at speeds below about 40 mph. As a result, a vehicle may experience brake noise while traveling at low speeds. This noise can cause customer complaints and can lead to extensive warranty costs. In the past, reduction of brake moan and groan involved changing brake pad lining materials, which can be both complex and costly.

### SUMMARY OF THE INVENTION

The invention relates to a brake pad for decreasing one of brake moan and groan, comprising a brake pad lining with at least one notch located at or near at least one peak area of wave propagation within the brake pad lining.

The invention also relates to a method of decreasing one of brake moan and groan in a brake pad, comprising providing a brake pad lining with at least one notch located at or near at least one peak area of wave propagation within the brake pad lining.

The invention further relates to a method of manufacturing a brake pad for decreasing one of brake moan and groan, comprising forming at least one notch in a lining of the brake pad, the at least one notch being located at or near at least one peak area of wave propagation within the brake pad lining.

The invention may include a notch at each peak area of wave propagation within the brake pad lining. The invention may also include notches that extend through the brake pad lining but do not extend through the back plate. The notches may be located at a top portion of the brake pad lining and at a bottom portion of the brake pad lining.

### BRIEF DESCRIPTION OF THE DRAWINGS

The accompanying drawings, which are incorporated herein and form part of the specification, illustrate the prior art and the present invention and together with the description, further serve to explain the principles of the invention and to enable a person skilled in the pertinent art to make and use the invention.

FIG. 1 illustrates a front perspective view of a disc brake assembly for use with an embodiment of a brake pad of the present invention.

FIG. 2 illustrates a rear perspective view of the disc brake assembly of FIG. 1.

FIG. 3 illustrates a top view of an embodiment of a brake pad of the present invention.

FIG. 4 illustrates a perspective view of the brake pad of FIG. 3.

FIG. 5 illustrates a velocity time domain comparison for an embodiment of a brake pad of the present invention.

FIG. 6 illustrates a velocity frequency domain comparison for the embodiment used for FIG. 5.

### DETAILED DESCRIPTION OF THE INVENTION

In accordance with an embodiment the present invention, one or more notches are provided in the brake pad lining to stop wave propagation within the lining. In an embodiment of the invention, the notches are only provided in the brake pad lining, and do not extend through the back plate, which maintains the structural integrity of the back plate. The notches are placed at or near peak areas of wave propagation within the brake pad lining. The term “notch,” as used herein, refers generally to an area where brake lining material has been removed, and may include a small hole or gap, which may not extend through the entire width of the brake pad lining.

Peak areas of wave propagation may be determined with, for example, known modeling and animation techniques, utilizing a finite element analysis. In a finite element analysis, an object is represented by a geometrically similar model consisting of multiple, linked, simplified representations of discrete regions—i.e., finite elements on an unstructured mesh (or grid). Equations of equilibrium, in conjunction with applicable physical considerations, are applied to each element, and a system of simultaneous equations is constructed. The system of equations is solved for unknown values using the techniques of linear algebra or nonlinear numerical schemes, as appropriate. While being an approximate method, the accuracy of the finite element analysis method can be improved by refining the mesh in the model using more elements and nodes. A finite element analysis mesh applied to an exemplary brake pad lining is illustrated in FIG. 4.

It was observed in the Operational Deflection Shapes (ODS) of finite element analysis, which is known to show the vibration pattern of a structure while it is in operation or under operational conditions, that the instability wave propagation of brake moan and groan propagated quickly along a circumferential direction of the rotor. It was determined that this wave propagation can be disturbed by one or more notches provided to impede energy accumulation at specific frequencies. An effective way of setting the notches may depend on the ODS pattern of the frequency. As stated above, the frequencies of brake moan ad groan are typically in the range of 100 Hz to 400 Hz.

The shape, size, and placement of the one or more notches can be based on manufacturing considerations and the peak areas of wave propagation for a particular pad. The one or more notches may be formed in the brake pad lining via a number of manufacturing methods, including molding or extraction from the lining after it is formed (e.g., by cutting, stamping, or machining. Pad size, shape, and material generally varies among vehicles and therefore the location of peaks may vary as well. In an embodiment of the invention, the shape of the notches may conform to the shape of one or more discrete elements of a finite element analysis mesh applied to the pad for determining the peak areas of wave propagation. Size, shape, and location can also be approximated based on general results of finite elements analyses in instances where analysis of individual brake pad designs is not practical.

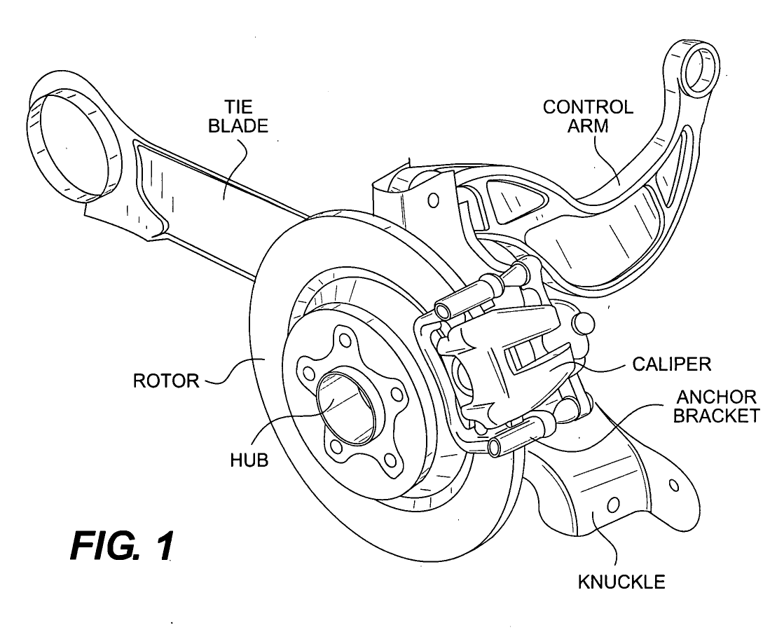

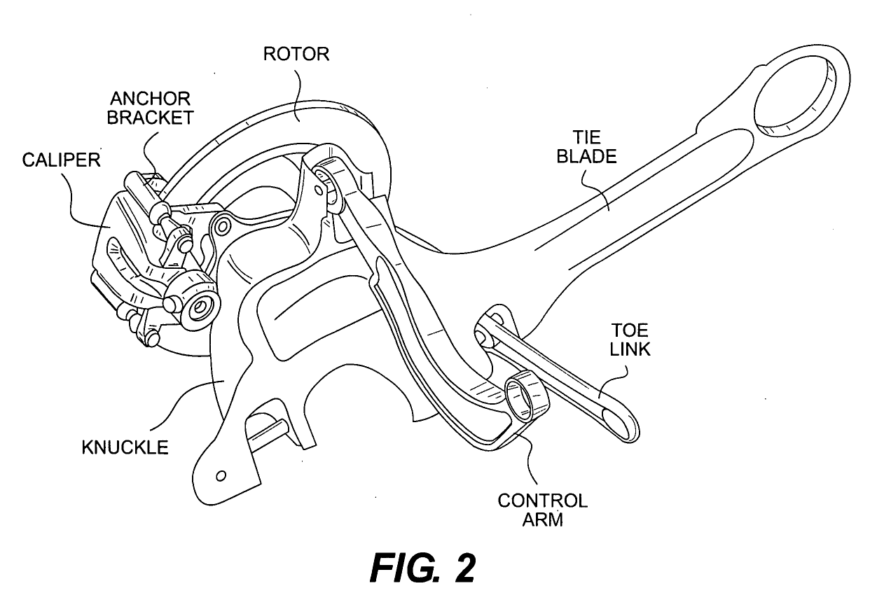

FIG. 1 illustrates a front perspective view of a disc braking assembly for use with an embodiment of a brake pad of the present invention. A disc brake slows or stops wheel rotation when brake pads, mounted in a caliper, are forced against a rotor. The design of rotors may vary. For example, they may be solid cast iron or hollowed out with fins joining the contact surfaces. A caliper is an assembly that houses the brake pads and pistons. Brake pads, such as those contemplated by the present invention, vary in size, shape, and material and are housed within calipers and moved via pistons. Calipers are generally floated or fixed. In a floated caliper, which moves relative to the rotor, a piston on one side of the rotor pushes the inner brake pad until it makes contact with the braking surface, and then pulls the caliper body with the outer brake pad so pressure is applied to both sides of the rotor. A fixed caliper applied both brake pads to the rotor surfaces at the same time.

The rotor and the caliper are mounted to a knuckle via an anchor bracket. The knuckle, also called the wheel flange, is connected to the vehicle frame via a suspension link called a control arm. A ball joint or bushing is generally used to link the control arm to the knuckle. The tie blade and toe link are suspension components that connect the wheel to the vehicle body.

The control arm, knuckle, tie blade, and toe link are components of a vehicle's suspension system. The components transfer loads from the road through the tire to the vehicle structure (body structure) and maintain vehicle maneuverability. The arrangement of these components may be a factor in triggering the occurrence of moan in the brake pads.

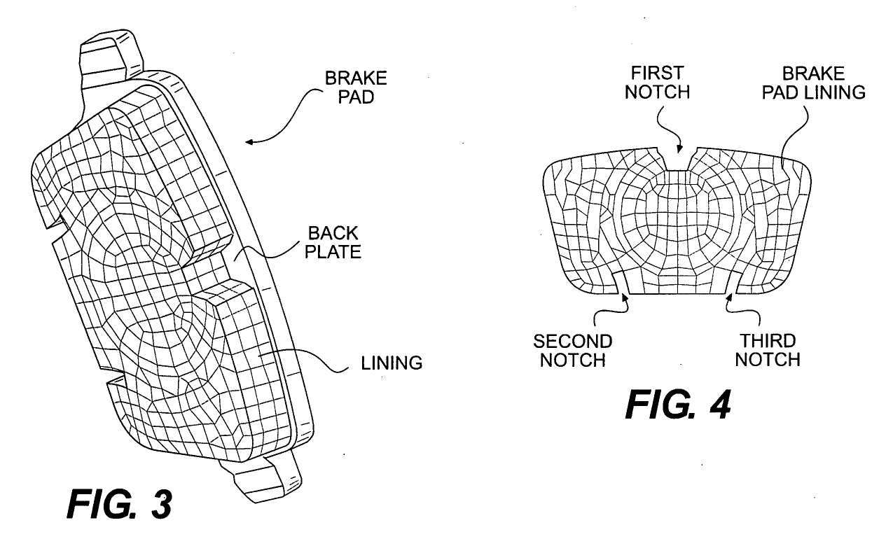

FIG. 3 illustrates a top view of an embodiment of a brake pad of the present invention. As shown, the brake pad lining includes three notches, including a first notch at a top portion of the brake pad lining and second and third notches at a bottom portion of the brake pad lining. While three notches are illustrated, the present invention contemplates one or more notches located at or near the peak areas of wave propagation for each pad, which areas can be determined by known modeling and animation techniques utilizing a finite element analysis. Not all of the peak areas of wave propagation must have an associated notch, although providing a notch at each peak area will provide better moan and groan mitigation.

In an exemplary embodiment such as that illustrated in FIGS. 3 and 4, a brake pad measures approximately 70 mm×40 mm. After determining the peak areas of wave propagation, the size of the first notch is approximately 6 mm×7 mm and the size of each of the second and third notches is approximately 4 mm×6 mm. Although the size of the notches will generally increase with the size of the brake pad lining, such correlation may not always be the case and notch size is preferably determined by studying the peak areas of wave propagation for each pad.

FIGS. 3 and 4 also illustrate an exemplary mesh (or grid) that can be used for a finite element analysis. The mesh creates multiple, linked, simplified representations of discrete regions for which the wave propagation attributes can be studied. It is the study of these attributes that allows identification of the peak areas of wave propagation and thus the desirable locations for placement of one or more notches. In the embodiment of FIGS. 3 and 4, the shape of the notches conforms to the shape of discrete elements of the mesh.

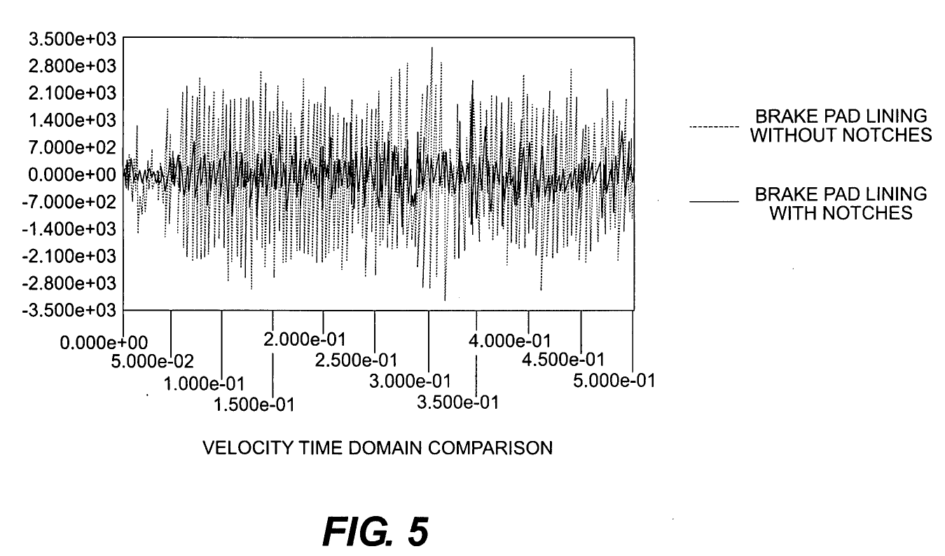

FIG. 5 illustrates a velocity time domain comparison for an embodiment of a brake pad of the present invention. The x-axis represents frequency in Hz and the y-axis represents velocity in mm/sec. This graph shows changes in amplitude of velocity of brake pad surfaces with and without notches over time during simulated vehicle operation. The graph was created by modeling vehicle operation using a finite element analysis as described above for an exemplary brake pad as shown in FIGS. 3 and 4, both with and without notches. As can be seen, the amplitude of the velocity is greater for a brake pad without notches. The amplitude of the peaks indicates generally the amount of noise a driver of the vehicle will hear. Thus, as can be seen, a driver will hear less moan and groan, if any, with brake pads having notches at peak areas of wave propagation.

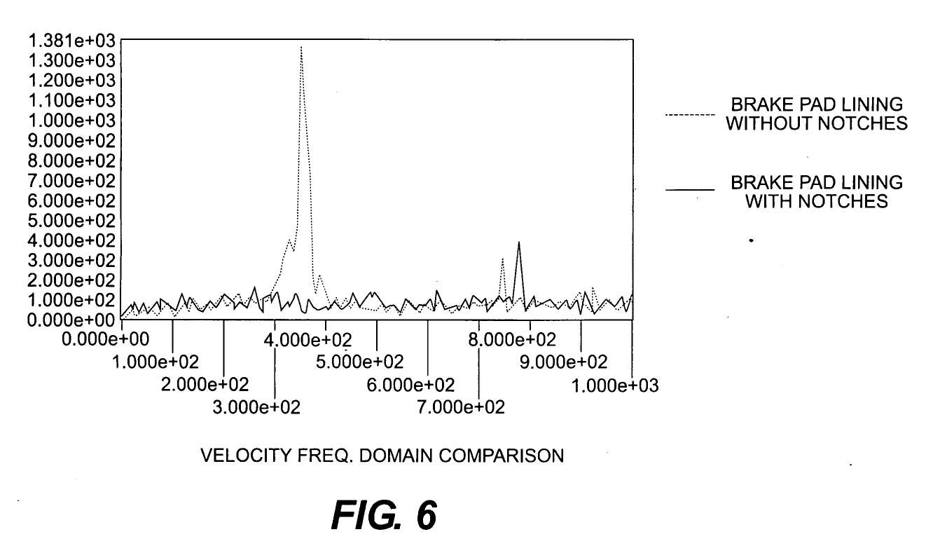

FIG. 6 illustrates a velocity frequency domain comparison for the brake pad embodiment used for FIG. 5. The x-axis represents time in seconds and the y-axis represents velocity in mm/sec. The graph can be created, for example, using known numerical analyses of the time domain data of FIG. 5. The peaks represent noise at varying frequencies for the exemplary brake pad as shown in FIGS. 3 and 4, both with and without notches. As can be seen, for a brake pad without notches, there is a peak of noise at about 350 Hz, which corresponds to the frequency of brake moan (100 Hz-400 Hz). For a brake pad having notches at peak areas of vibration, there is no corresponding peak within the illustrated frequency range. Thus, moan and groan is reduced or eliminated with brake pads having notches at peak areas of wave propagation.

It is to be understood that the present invention contemplates generally a brake pad lining having one or more notches located at or near one or more peak areas of wave propagation within the brake pad lining. The number, size, and shape of the notches may vary and remain within the scope of the invention, which is set forth below in the claims.

What is claimed is:

1. A brake pad for decreasing one of brake moan and groan, comprising,
a brake pad lining with at least one notch located at or near at least one peak area of wave propagation within the brake pad lining.

2. The brake pad of claim 1, including a notch at each peak area of wave propagation within the brake pad lining.

3. The brake pad of claim 1, wherein the at least one notch extends through the brake pad lining.

4. The brake pad of claim 1 including a back plate to which the brake pad lining is attached, wherein the at least one notch does not extend through the back plate

5. The brake pad of claim 1, including a notch at a top portion of the brake pad lining.

6. The brake pad of claim 1, including a notch at a bottom portion of the brake pad lining.

7. The brake pad of claim 6, including two notches at a bottom portion of the brake pad lining.

8. The brake pad of claim 1, including a notch at a top portion of the brake pad lining and a notch at a bottom portion of the brake pad lining.

9. The brake pad of claim 8, including two notches at a bottom portion of the brake pad lining.

10. A method of decreasing one of brake moan and groan in a brake pad, the method comprising,
providing a brake pad lining with at least one notch located at or near at least one peak area of wave propagation within the brake pad lining.

11. The method of claim 10, wherein at least one notch is provided at each peak area of wave propagation within the brake pad lining.

12. The brake pad of claim 10, wherein the at least one notch extends through the brake pad lining.

13. The brake pad of claim 10, wherein a notch is provided at a top portion of the brake pad lining.

14. The brake pad of claim 10, wherein a notch is provided at a bottom portion of the brake pad lining.

15. The brake pad of claim 10, wherein two notches are provided at a bottom portion of the brake pad lining.

16. A method of manufacturing a brake pad for decreasing one of brake moan and groan, the method comprising,
forming at least one notch in a lining of the brake pad, the at least one notch being located at or near at least one peak area of wave propagation within the brake pad lining.

17. The method of claim 16, wherein at least one notch is provided at each peak area of wave propagation within the brake pad lining.

18. The brake pad of claim 16, wherein the at least one notch extends through the brake pad lining.

19. The brake pad of claim 16, wherein a notch is provided at a top portion of the brake pad lining.

20. The brake pad of claim 16, wherein a notch is provided at a bottom portion of the brake pad lining.

21. The brake pad of claim 16, wherein two notches are provided at a bottom portion of the brake pad lining.
